(19) United States
(12) Patent Application Publication
(10) Pub. No.: US 2016/0302413 A1
(43) Pub. Date: Oct. 20, 2016

(54) PESTICIDAL COMPOSITIONS AND METHODS OF USING SAME

(71) Applicant: BEDOUKIAN RESEARCH, INC., Danbury, CT (US)

(72) Inventor: Robert H. BEDOUKIAN, West Redding, CT (US)

(73) Assignee: BEDOUKIAN RESEARCH, INC., Danbury, CT (US)

(21) Appl. No.: 15/097,586

(22) Filed: Apr. 13, 2016

Related U.S. Application Data
(60) Provisional application No. 62/148,522, filed on Apr. 16, 2015.

(51) Int. Cl. A01N 43/50; A01N 35/06; A01N 31/06; A01N 47/06; A01N 57/28; A01N 57/12; A01N 47/22; A01N 37/34; A01N 31/14; A01N 55/00; A01N 43/56; A01N 53/00; A01N 59/04; A01N 59/00; A01N 25/08

(52) U.S. Cl. CPC A01N 43/50; A01N 25/08; A01N 35/06; A01N 31/06; A01N 47/06; A01N 57/28; A01N 57/12; A01N 47/22; A01N 37/34; A01N 31/14; A01N 55/00; A01N 43/56; A01N 53/00; A01N 59/04; A01N 59/00

(57) ABSTRACT

A method for controlling or killing pests (e.g., bed bugs). The method includes providing at a location a composition comprising a pest toxicant (e.g., permethrin or a pyrethroid) and an organic nitrogenous compound (e.g., histamine). The organic nitrogenous compound is capable of attracting, arresting, aggregating and/or altering the behavior of the pests at the location. A composition containing a pest toxicant (e.g., permethrin or a pyrethroid) and an organic nitrogenous compound (e.g., histamine) capable of attracting, arresting, aggregating and/or altering the behavior of one or more pests (e.g., bed bugs). A method of attracting, arresting, aggregating and/or altering the behavior of pests (e.g., bed bugs) at a location. The method includes providing at the location a composition comprising an organic nitrogenous compound (e.g., histamine). A composition containing an organic nitrogenous compound (e.g., histamine) capable of attracting, arresting, aggregating and/or altering the behavior of one or more pests (e.g., bed bugs).

### RELATED APPLICATION

This application claims the benefit of copending U.S. Application No. 62/148,522, filed Apr. 16, 2015, which is incorporated herein by reference in its entirety.

### BACKGROUND OF THE DISCLOSURE

1. Field of the Disclosure

This disclosure relates to pesticidal compositions (e.g., insecticidal compositions) and methods of using the pesticidal compositions. The pesticidal compositions comprise a pest toxicant and an organic nitrogenous compound (e.g., histamine) capable of attracting, arresting, aggregating and/or altering the behavior of one or more pests (e.g., insects such as bed bugs).

2. Description of the Related Art

Recent data suggests bedbug infestations (Cimex species) of human domiciles are on the rise. At least 92 species of bed bugs have been identified globally, of which at least 16 species are in the North American continent. Generally, bed bugs are parasitic pests with its hosts including humans and various domesticated animals. It is believed that bedbug infestations are becoming more problematic now at least in part because long acting, residual insecticides are no longer being used to keep bedbug populations in check. In addition, increased international travel and insecticide resistance have made bedbug infestations spread and made control with insecticides very difficult. In terms of scale, such infestations are of particular concern for hoteliers, cruise ships, trains, daycare facilities, and the like because of the business reputation risk posed by bad press or bad reviews. Other problematic areas tend to include nursing homes, barracks, dorms, hospitals, and various other forms of high density housing. Nonetheless, single family homes can likewise be impacted adversely.

Bed bugs feed on human blood. Thus, bed bugs are not merely unsightly, they leave ugly skin markings. However problematic this is for residential bedrooms, it is an even more serious problem for motels and the like. With respect to such commercial bedrooms there is more opportunity for external infection sources to bring bed bugs to the site because of the volume of people that move through commercial bedrooms versus residential bedrooms, and should there be an unknown infestation which causes biting of customers before it is dealt with, there is a severe risk of customer dissatisfaction and adverse publicity, likely leading to a long term significant reputation loss.

There have been attempts to control bedbug infestation through applications of insecticidal chemicals to infected areas and materials (especially mattresses). This approach has some drawbacks. For example, it can expose those using a treated area or mattress too soon after application to odor or other undesired characteristics of the pesticidal chemical. Further, unless the chemicals are used regularly, without regard to whether an infestation is known to already exist (a procedure which will significantly increase costs), those sleeping in an infected area can be bitten before one knows to begin treatment.

Another reason for the increase in bed bugs is that pest control services more often nowadays use low toxicity gel-based pesticides for control of cockroaches, the most common pest in structures, instead of residual sprays. When residual sprays meant to kill other insects were commonly being used, they resulted in a collateral insecticidal effect on potential bedbug infestations. The gel-based insecticides primarily used nowadays do not have any effect on bed bugs, as they are incapable of feeding on these baits. One of the most significant problems in controlling bed bugs is the loss of the ability to use organophosphate pesticides which were very effective, followed by widespread resistance to the use of pyrethroid pesticides which replaced them.

There is, therefore, a need for methodology that can be used to improve the toxicant effects of pesticides against bed bugs and for safe and effective means to employ such chemicals.

There is also a need for compounds and compositions capable of attracting pests and treating pest infestation. Such compounds and compositions may be used together with devices to detect pest infestation, with traps to capture pests for detection or mitigation of infestation, or with pesticides to treat infestations.

The present disclosure provides many advantages, which shall become apparent as described below.

### SUMMARY OF THE DISCLOSURE

This disclosure relates to pesticidal compositions (e.g., insecticidal compositions) and methods of using the pesticidal compositions. The pesticidal compositions comprise a pest toxicant (e.g., permethrin or a pyrethroid or a compound of structure (I) described herein) and an organic nitrogenous compound (e.g., histamine) capable of attracting, arresting, aggregating and/or altering the behavior of one or more pests (e.g., insects such as bed bugs).

This disclosure relates in part to a method for controlling or killing pests (e.g., insects such as bed bugs). The method comprises providing at a location a composition comprising a pest toxicant (e.g., permethrin or a pyrethroid or a compound of structure (I) described herein) and an organic nitrogenous compound (e.g., histamine). The organic nitrogenous compound is capable of attracting, arresting, aggregating and/or altering the behavior of the pests at the location.

This disclosure also relates in part to a method of attracting, arresting, aggregating and/or altering the behavior of pests (e.g., insects such as bed bugs) at a location. The method comprises providing at the location a composition comprising an organic nitrogenous compound (e.g., histamine).

This disclosure further relates in part to a composition comprising a pest toxicant (e.g., permethrin or a pyrethroid or a compound of structure (I) described herein) and an organic nitrogenous compound (e.g., histamine) capable of attracting, arresting, aggregating and/or altering the behavior of one or more pests (e.g., insects such as bed bugs).

This disclosure yet further relates in part to a composition comprising an organic nitrogenous compound (e.g., histamine) capable of attracting, arresting, aggregating and/or altering the behavior of one or more pests (e.g., insects such as bed bugs).

Further objects, features and advantages of the present disclosure will be understood by reference to the following drawings and detailed description.

### DESCRIPTION OF THE EMBODIMENTS

In an embodiment, this disclosure relates to the killing of bed bugs by attracting the bed bugs to a surface treated with a toxic amount of a pesticide, and maintaining that contact for an extended period of time with the use of a compound that is capable of attracting, arresting, aggregating, and/or controlling bed bugs (e.g., histamine). The compound capable of attracting, arresting, aggregating, and/or controlling bed bugs causes the bed bugs to remain on a treated surface. The method of this disclosure eliminates the need to have the pesticide sprayed on all surfaces which bed bugs may contact, and causes the bed bugs to remain in contact with the pesticide for an extended period of time, which increases the efficacy of the pesticide.

In another embodiment, this disclosure provides methods of attracting, detecting, eradicating, controlling, and/or killing a pest by utilizing an organic nitrogenous compound (e.g., histamine) described herein.

In yet another embodiment, this disclosure provides bait compositions comprising an organic nitrogenous compound (e.g., histamine) described herein. In an aspect, the disclosure provides for a method of treating a pest infestation and/or determining the presence of a pest, by providing a bait material comprising an organic nitrogenous compound (e.g., histamine) described herein. The bait composition can be used in any of the methods described herein and can include a pesticide.

In still another embodiment, this disclosure provides a detection device or trap containing an organic nitrogenous compound (e.g., histamine) described herein. In an aspect, a bait composition can be used with the detection device or trap. In an aspect, the disclosure provides for a detection device for monitoring the presence of bed bugs and/or infestation, comprising a first plate and a second plate, wherein the first plate and the second plate are separated by an internal spacing sized to permit entry into the detection device by one or more bed bugs; and an organic nitrogenous compound (e.g., histamine) described herein.

In another embodiment, this disclosure provides a support material comprising an organic nitrogenous compound (e.g., histamine) described herein. In one aspect, the support material is coated or impregnated with an organic nitrogenous compound (e.g., histamine) described herein. The support material may be, for example, an absorbent material, wood, cardboard, corrugated cardboard, cotton, wallpaper, paper, plastic, a plastic tube, or metal.

In yet another embodiment, this disclosure provides a method of luring, arresting, and/or aggregating a pest into an area treated with a pest attractant, arresting, and/or aggregation compound (i.e., an organic nitrogenous compound (e.g., histamine) described herein). In one aspect, the treated area is a support material capable of being coated or impregnated with an organic nitrogenous compound (e.g., histamine) described herein.

In still another embodiment, a pest attractant, arresting, and/or aggregation compound or composition (i.e., an organic nitrogenous compound (e.g., histamine) described herein) can be combined with a pesticide or pheromone. In another aspect, the compositions, methods, and/or devices described herein do not include a pesticide.

In another aspect, the bed bug is from the species Cimex lectularius. While the instant disclosure focuses on utilizing an organic nitrogenous compound (e.g., histamine) described herein as an attractant, arresting, and/or aggregation compound as well as a compound that influences the behavior of bed bugs, the instant disclosure can well be translated to be utilized with other related, blood-feeding arthropods or insects because species that share a similar food source and/or similar benefits of aggregations and are related may also share common attractants, arrestants, aggregation compounds or other pheromones.

In an aspect, the pest in the above methods is an insect and the insect in the above methods is a bed bug.

Among the various methods in which the formulations of this disclosure may be employed are (1) injecting or spraying the formulations into or onto a mattress, either directly or in combination with other ingredients or solvents, (2) placing the formulations on an absorbent material and placing the absorbent material in a sachet and placing the sachet containing the formulation into a locus such as, including but not limited to, a mattress, hamper, suitcase, clothing bag, linen storage closet or any other enclosure where bed bugs may be present, (3) preparing “dryer sheets” containing the formulations for placement in a locus such as, including but not limited to, a mattress, suitcase, clothing bag, hamper, clothing bag, linen storage closet, or any other enclosure where bed bugs are likely to be present, or in a pile of clean or soiled laundry, (4) placing the formulation into detergent or fabric softener compositions for killing of bed bugs during use of these compositions in cleaning clothes and sprays or in carpet or floor cleaner products and the like to treat carpets and furniture, and (5) spraying a formulation containing the compounds of structure (I) with or without a co-formulant on surfaces, luggage, furniture, into crevices, or behind fixtures.

In an embodiment where the formulations of this disclosure may prevent pests (e.g., bed bugs) from biting or feeding, a topical application of the formulation intended for use with humans or animals, such as in the form of, including but not limited to, a lotion, wipes, powder, spray or shampoo, may be employed.

This disclosure provides compositions comprising a pest attractant, arrestant and/or aggregant compound described herein together with a pesticide (e.g., an insecticide). Any pesticide (e.g., an insecticide) can be used in connection with the present compositions and methods. Notably, for example, any pesticide (e.g., an insecticide) capable of killing an insect, such as a bed bug, can be combined with insect attractant, arrestant and/or aggregant compounds described herein.

Illustrative pesticides (e.g., insecticides) useful in the compositions of this disclosure include, for example, carbamates, pyrethroids, phenylpyrazoles, such as fipronil or ethiprole, chloronicotinyles, imidacloprid, acetamiprid, thiacloprid, thiamethoxam, nitenpyram, clothianidin, oxadiazines, anthranilic diamides, butenolides, sulfoximines, indoxacarb, rynaxypyr, and the like.

Other illustrative pesticides (e.g., insecticides) include, for example, compounds represented by structure (I)

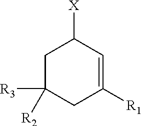

wherein X is selected from —OH, ═O, —O(O)CR, where R is selected from H and a branched or straight chain, saturated or unsaturated hydrocarbyl group with zero to three double bonds and from 1 to 11 carbon atoms;
R₁ is selected from H, CH₃;
R₂ is selected from H, CH₃;
R₃ is selected from H and a branched or straight chain, saturated or unsaturated hydrocarbyl group with zero to three double bonds and from 1 to 11 carbon atoms, and
wherein the compounds of structure (I) contain from 6 to 20 total carbon atoms in the compounds.

This disclosure also includes optical isomers, diastereomers and enantiomers of the compounds of structure (I). Thus, at all stereocenters where stereochemistry is not explicitly defined, all possible epimers are envisioned.

Representative examples of compounds of structure (I) include, but are not limited to:

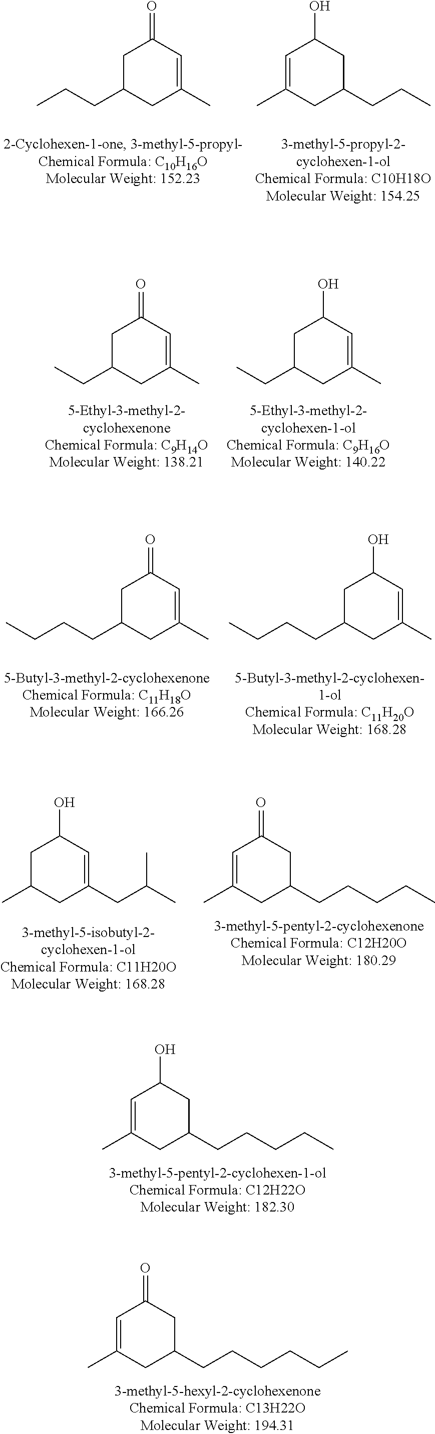

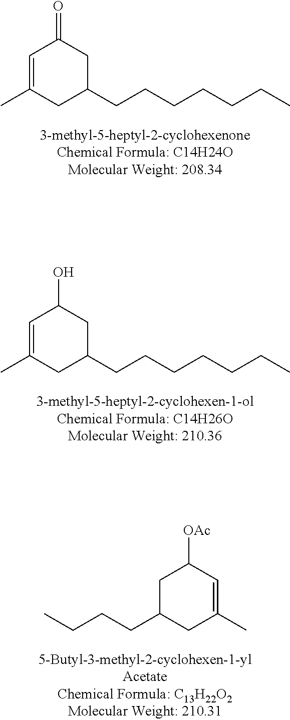

A group of especially preferred compounds of structure (I) for the purpose of vapor toxicity is 3-methyl-5-propyl-2-cyclohexen-1-one, 3-methyl-5-propyl-2-cyclohexen-1-ol and 3-methyl-5-ethyl-2-cyclohexen-1-one.

A group of especially preferred compounds of structure (I) for the purpose of contact toxicity is 3-methyl-5-butyl-2-cyclohexen-1-one, 3-methyl-5-pentyl-2-cyclohexen-1-one, 3-methyl-5-hexyl-2-cyclohexen-1-one, and 3-methyl-5-heptylcyclohexen-1-one.

Other illustrative pesticides (e.g., insecticides) which can be admixed include, for example, phosphoric esters, such as acephate, chlorpyrifos, dichlorovos, malathion or propetamphos; carbamates, such as bendiocarb, carbaryl, or propoxur; pyrethroids, such as allethrin, bifenthrin, bioallethrin, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, esfenvalerate, etofenprox, fenpropathrin, fenvalerate, flumethrin, tau-fluvalinate, halfenprox, imiprothrin, permethrin, phenothrin, prallethrin, pyrethrins (pyrethrum), resmethrin, silafluofen, tefluthrin, tetramethrin or transfluthrin; nitroimines and nitromethylenes, such as 1-[(6-chloro-3-pyridinyl)-methyl]-4,5-dihydro-N-nitro-1H-imidazol-2-amine (imidacloprid), N—R6-chloro-3-pyridyl)methyldN²-cyano-N′-methylacetamide (NI-25); phenylpyrazoles, such as fipronil or ethiprole; avermectins, such as abamectin or emamectin benzoate; spinosyns, such as spinosad or spinetoram; oxadiazines, such as indoxacarb or metaflumizone; anthranilic diamides, such as flubendiamid, chlorantraniliprole or cyantraniliprole; sulfoximines, such as sulfoxaflor; insect growth regulators, such as methoprene, chlorfluazuron, flufenoxuron, pyriproxyfen, triflumuron or flufenoxuron; and other insecticidally active compounds, such as azadirachtin, chlorfenapyr, hydramethylnon, petroleum oils or botanical oils. Any of the above pesticide (e.g., insecticide) compositions can be used in conjunction with the pest attractant, arresting, and/or aggregation compounds and compositions described herein.

In some embodiments, the pesticide (e.g., insecticide) includes, but is not limited to, pyrethrum, pyrethrins, pyrethroids, spinosad, neonicotinoids, sulfoxoflor, carbamates, organophosphates, and organochlorines.

The pesticide (e.g., insecticide) can be present in an amount of at least about 0.005%, at least about 0.01%, at least about 0.05%, at least about 0.1%, at least about 0.5%, at least about 1%, at least about 2%, at least about 3%, at least about 4%, at least about 6%, at least about 8%, at least about 10%, at least about 12%, at least about 15%, at least about 20%, at least about 25%, at least about 30%, at least about 35%, at least about 40%, at least about 50% or at least about 55%, at least about 60%, at least about 65%, at least about 70%, at least about 75%, at least about 80%, at least about 85%, at least about 90%, at least about 95%, and less than about 95%, less than about 90%, less than about 80%, less than about 75%, less than about 70%, less than about 65%, less than about 60%, less than about 55%, less than about 50%, less than about 45%, less than about 35%, less than about 30%, less than about 25%, less than about 20%, less than about 15%, less than about 10%, less than about 5%, less than about 2.5%, less than about 2%, less than about 1%, less than about 0.5%, or less than about 0.1% by weight of the composition.

Illustrative pyrethrums or pyrethrins useful in the compositions of this disclosure include, for example, Jasmolin-I (CAS No. 4466-14-2), Cinerin-I (CAS No. 25402-06-6), Pyrethrin-I (CAS No. 121-21-1), Jasmolin-II (CAS No. 1172-63-0), Cinerin-II (CAS No. 121-20-0), and Pyrethrin-II (CAS No. 121-29-9).

While the terms “pyrethrins” and “pyrethrum” are sometimes used interchangeably, “pyrethrum” should be understood here to encompass crude extracts that contain pyrethrins. The pyrethrins in any given pyrethrum extract vary in relative amount, depending on factors such as the plant variety, where it is grown, and the time of harvest.

Pyrethrins are commercially available from several sources throughout the world and, in the United States, are available from several sources including the product sold under the trade name Pyganic™ MUP 20 by MGK (Minneapolis, Minn.).

Illustrative pyrethroids useful in the compositions of this disclosure include, for example, acrinathrin, allethrin, benfluthrin, benzylnorthrin, bioallethrin, bioethanomethrin, bioresmethrin, bifenthrin, cyclethin, cycloprothrin, cyfluthrin, beta-cyfluthrin, gamma-cyhalothrin, lamdba-cyhalothrin, cypermethrin, alpha-cypermethrin, beta-cypermethrin, zeta-cypermethrin, cyphenothrin, deltamethrin, empenthrin, esbiothrin, esfenvalerate, etofenprox, fenfluthrin, fenpropathrin, fenvalerate, flucythrinate, flumethrin, imiprothin, isopyrethrin I, kadethrin, metofluthrin, permethrin, 1RS cis-permethrin, phenothrin, prallethrin, resmethrin, silafluofen, sumithrin (d-phenothrin), tau-fluvalinate, tefluthrin, tetramethrin, tralomethrin, transfluthrin, and isomers of these compounds. Etofenprox, a recently registered pyrethroid, contains an ether bond as its central linkage rather than an ester bond. In certain embodiments, the pyrethroid comprises at least one of permethrin, sumithrin, prallethrin, resmethrin, etofenprox, allethrin, alpha-cypermethrin, bifenthrin beta-cypermethrin, cyfluthrin, cypermethrin, deltamethrin, esfenvalerate, etofenprox, lamdba-cyhalothrin, and zeta-cypermethrin, which may be used with, for example, perilla oil, perillaldehyde or carvone.

Spinosad is an insecticide derived from Saccharopolyspora spinosa. S. spinosa occurs in over 20 natural forms, and over 200 synthetic forms (spinosoids). As used in this specification, spinosad includes at least one of Spinosyn A, Spinosyn D, or a combination thereof.

Neonicotinoids are insecticides that act on the central nervous system of insects. Neonicotinoids include, but are not limited to, acetamiprid, clothianidin, dinotefuran, imidacloprid, nitenpyram, thiacloprid, and thiamethoxam.

Carbamates are organic compounds derived from carbamic acid (NH₂COOH) and feature the carbamate ester functional group. Carbamates include, but are not limited to, aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb, and triazamate.

Organophosphates are esters of phosphoric acid which act on the enzyme acetylcholinesterase. Organophosphates include, but are not limited to, acephate, azamethiphos, azinphos-ethyl, azinphos-methyl, chlorethoxyfos, chlorfenvinphos, chlormephos, chlorpyrifos, methyl chlorpyrifos, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, flupyrazophos, fosthiazate, heptenophos, isoxathion, malathion, mecarbam, methamidophos, methidathion, mevinphos, monocrotophos, omethoate, oxydemeton-methyl, parathion, methyl parathion, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, and vamidothion.

Organochlorines are organic compounds containing at least one covalently bonded chlorine atom. Organochlorines include, but are not limited to, phthalimides, sulfamides, and chloronitriles, including, but not limited to, anilazine, captan, chlorothalonil, captafol, chlordane, dichlorodiphenyltrichloroethane (DDT), dicofol, dichlofluanid, dichlorophen, endosulfan, flusulfamide, folpet, hexachlorobenzene, heptachlor, pentachlorphenol and its salts, aldrin, dieldrin, endrin, mirex, phthalide, and tolylfluanid, N-(4-chloro-2-nitro-phenyl)-N-ethyl-4-methyl-benzenesulfonamide.

As used herein, the active agent refers to the toxic agent, the attractant, arrestant and/or aggregant compound, alone or a combination thereof.

As described herein, toxic agents may include, but are not limited to, pesticides, insecticides, larvacides, ovicides, adulticides, nematicides, acaricides, bactericides, miticides, algicides, germicides, repellents, nutrients, and combinations thereof. Specific examples of insecticides include, but are not limited to, a botanical, a carbamate, a microbial, a dithiocarbamate, an imidazolinone, an organophosphate, an organochlorine, a benzoylurea, an oxadiazine, a spinosyn, a triazine, a carboxamide, a tetronic acid derivative, a triazolinone, a neonicotinoid, a pyrethroid including pyrethoid esters such as deltamethrin, a pyrethrin, and a combination thereof. Specific examples of acaricides or miticides include, without limitation, rosemary oil, thymol, spirodiclogen, cyflumetofen, pyridaben, diafenthiuron, etoxazole, spirodiclofen, acequinocyl, bifenazate, and a combination thereof. One example of such a toxic agent is spinosad.

Although referred to herein as “attractants”, the compositions or compounds may or may not function as classical attractants, i.e., compositions that attract pests to a site. In fact, without being limited as to theory, it is believed that the compositions or compounds may also serve as arrestants that cause pests to stay at a site longer and/or aggregants that cause pests to aggregate at a site.

Although referred to herein as “arrestants” or “aggregants”, the compositions or compounds may or may not function as classical arrestants, i.e., compositions that cause pests to stay longer at a site, or aggregants, i.e., compositions that cause pests to aggregate at a site. In fact, without being limited as to theory, it is believed that the compositions or compounds may also serve as attractants that cause pests to be attracted to a site.

Illustrative preferred attracting, arresting, controlling, and/or aggregating compounds useful in the compositions of this disclosure include, for example, an organic nitrogenous compound (e.g., histamine) and derivatives thereof (e.g., histamine as a free base), as described herein.

The attracting, arresting, controlling, and/or aggregating compounds can be present in an amount of at least about 0.005%, at least about 0.01%, at least about 0.05%, at least about 0.1%, at least about 0.5%, at least about 1%, at least about 2%, at least about 3%, at least about 4%, at least about 6%, at least about 8%, at least about 10%, at least about 12%, at least about 15%, at least about 20%, at least about 25%, at least about 30%, at least about 35%, at least about 40%, at least about 50% or at least about 55%, at least about 60%, at least about 65%, at least about 70%, at least about 75%, at least about 80%, at least about 85%, at least about 90%, at least about 95%, and less than about 95%, less than about 90%, less than about 80%, less than about 75%, less than about 70%, less than about 65%, less than about 60%, less than about 55%, less than about 50%, less than about 45%, less than about 35%, less than about 30%, less than about 25%, less than about 20%, less than about 15%, less than about 10%, less than about 5%, less than about 2.5%, less than about 2%, less than about 1%, less than about 0.5%, or less than about 0.1% by weight of the composition.

In addition, the compositions of this disclosure and methods for their use can include other actives and inactives as well known in the art.

In another aspect, the attractant, arresting, and/or aggregation compounds described herein may be combined with other compounds. In an aspect, other compounds or compositions capable of being combined with attractant, arresting, and/or aggregation compounds described herein include those disclosed in “Identification of the Airborne Aggregation Pheromone of the Common Bed Bug, Cimex lectularius”, Journal of Chemical Ecology, vol. 34, no. 6, June 2008, which is incorporated herein by reference in its entirety. Other suitable attractants or arrestants include food attractants in any form, such as in solid, gel or liquid form. It is also possible to utilize carbon dioxide, ammonia (or an ammonium salt), heat, methanol, methane, furan, pyridine, human perspiration, lactic acid, butyric acid, octenol, trans-2-octenal, trans-2-hexenal, 2-butanone, lactic acid, indole, 6-methyl-5-hepten-2-one, geranyl acetone, 1-dodecanol, 3-methyl-1-butanol, carboxylic acids, urea, and sebum (a component of skin oil). Suitable attractants or arrestants also can include one or more harboraging agents. Any of the above compounds or compositions attractants or arrestants may also be used in conjunction with compounds or compositions described herein.

Compounds and compositions of the disclosure may be present in any amount sufficient to attract, arrest, aggregate, control, a pest, such as a bed bug. In an aspect, the disclosure provides for a composition comprising from about 200 ng/square inch to about 10 mg/square inch of an attractant, arresting, and/or aggregation compound described herein. In another aspect, an attractant, arresting, and/or aggregation compound described herein can be present in an amount from about 500 ng/square inch to about 5 mg/square inch, from about 500 ng/square inch to about 2 mg/square inch, from about 500 ng/square inch to about 1 mg/square inch, from about 1000 ng/square inch to about 1 mg/square inch, from about 0.01 mg/square inch to about 5 mg/square inch, from about 0.01 mg/square inch to about 1 mg/square inch, from about 0.1 mg/square inch to about 5 mg/square inch, from about 0.1 mg/square inch to about 1 mg/square inch; from about 0.5 mg/square inch to about 2 mg/square inch, and from about 0.5 mg/square inch to about 1 mg/square inch. In another aspect, an attractant, arresting, and/or aggregation compound described herein can be present in an amount from about 100 ng/square inch to about 5000 ng/square inch, from about 100 ng/square inch to about 1000 ng/square inch, and from about 100 ng/square inch to about 500 ng/square inch.

In an aspect, for long duration lure, the disclosure provides for a composition comprising from about 1 mg to about 1 g of an attractant, arresting, and/or aggregation compound described herein. In another aspect, for short duration lure, an attractant, arresting, and/or aggregation compound described herein can be present in an amount from about 10 μg to about 2 mg.

In another aspect, a composition of the disclosure can contain from about 0.1% to about 99.9% by weight of an attractant, arresting, and/or aggregation compound according to the disclosure. In another aspect, a composition of the disclosure can contain from about 10% to about 90%, from about 20% to about 80%, from about 25% to about 75%, from about 30% to about 70%, or from about 40% to about 60% by weight of a pesticide or an attractant, arresting, and/or aggregation compound according to the disclosure.

In yet another aspect, a composition of the disclosure can contain from about 10%, about 20%, about 30%, about 40%, about 50%, about 60%, about 70%, about 80%, or about 90% by weight of a compound or pesticide according to the disclosure. Compositions of the disclosure can also contain from about 10% or more, about 20% or more, about 30% or more, about 40% or more, about 50% or more, about 60% or more, about 70% or more, about 80% or more, or about 90% or more by weight of a compound or pesticide according to the disclosure by weight of an pesticide or pest attractant, arresting, and/or aggregation compounds according to the disclosure.

Components of a composition of this disclosure can have a synergistic or additive effect on pesticidal activity. Components have an additive effect when the effect of the combination is equal to the sum of the effects of each individual component. In contrast, components have a synergistic effect when the effect of the combination exceeds the sum of the effects of the components when applied individually. The effect (E) of a combination of two compounds may be calculated using the Colby formula (1) (S. R. Colby, “Calculating Synergistic and Antagonistic Responses of Herbicide Combinations”, Weeds 1967, 15, 20-22):

$$E = X + Y - \frac{X \times Y}{100}$$

wherein X is the kill rate, expressed as a percentage of the untreated control, when employing active compound X′ at an application rate of m g/ha or in a concentration of m ppm, μg, or other appropriate unit; wherein Y is the kill rate, expressed as a percentage of the untreated control, when employing active compound Y′ at an application rate of n g/ha or in a concentration of n ppm, μg, or other appropriate unit; wherein E is the kill rate, expressed as a percentage of the untreated control, when employing active compounds X′ and Y′ at application rates of m and n g/ha or in a concentration of m and n ppm. If the actual pesticidal kill rate is the calculated value (E), then the action of the combination is additive. If the actual pesticidal kill rate exceeds the calculated value (E), then the action of the combination is super-additive, that is, a synergistic effect is present. If the pesticidal kill rate is lower than the calculated value (E), then the action of the combination is considered antagonistic.

In an embodiment, the organic nitrogenous compound can have synergistic activity with pesticides (e.g., insecticides) such as pyrethrum, pyrethrins, pyrethroids, spinosad, neonicotinoids, sulfoxoflor, carbamates, organophosphates, and organochlorines.

Embodiments include commercially useful formulations or “ready-to-use” application forms. In such formulations, the composition can be suitably provided as a mixture with other active compounds, for example, various additional pesticides, insecticides, fungicides, anti-microbials, and/or herbicides, as well as plant growth regulators, insect repellents, attractants, fertilizers, and/or fragrances, to expand the applicability of the pesticidal composition described in this specification. Embodiments provide for the compositions manufactured as formulations that are useful for pest control. In some embodiments, the composition can be formulated as an emulsion, a liquid concentrate, a sol (flowable agent), an aerosol (e.g., fogger), a liquid for ultra low volume (ULV) application, a mist, a spray, a vapor, a surface contact treatment, or incorporated into fibers or other materials such as a bednet, or the like, by any standard or conventional methods for mixing and manufacturing such formulations such as, for example, admixing active agent and an amount of mineral oil, glycerol, other viscosity modifier, or combination thereof, and optionally with one or more of any suitable additional inert ingredient that is used as a carrier, solvent, diluent, emulsifier, dispersant, stabilizers, suspending agent, or penetrant. The addition of these materials would depend on the active ingredient and the type of formulation and how it is intended to be applied. Compositions suitable for a particular application type can be formulated by those of skill in the art based on standard and conventional methods using guidance provided in this specification.

In some embodiments, the composition can be formulated for application or delivery as an aerosol or a fog wherein the composition allows for the formation of droplets having an average diameter of about 1 μm to about 30 μm. Suitable compositions for such a formulation typically should have a viscosity that allows for the composition to atomize, but not be so thick as to clog the nozzle. Such viscosities can vary and be readily determined by one of skill in the art; however, a non-limiting common minimum viscosity is about 70 centistokes (cts).

The compositions of this disclosure can be generally prepared by any appropriate manufacturing processes and using any appropriate manufacturing equipment such as is known in the art. Suitably, the compositions can be prepared by combining the various components in an appropriate vessel (considering vessel size, amount of composition to be made and reactivity of components) with mixing (e.g., stirring) until a uniform or homogeneous composition is achieved. The various composition components can be added sequentially, with stirring between each addition to ensure dissolution and/or dispersion of the previous component. This may be followed by addition of one or more additional components (e.g., solvents, diluents, and carriers) with stirring to provide a homogeneous composition.

In a non-limiting aspect, compositions according to this disclosure may be formulated and used in various forms, such as aerosol dispenser, bait (ready for use), bait concentrate, block bait, capsule suspension, cold fogging concentrate, dustable powder, emulsifiable concentrate, emulsion oil in water, emulsion water in oil encapsulated granule, fine granule, grain bait, granular bait, granule, macrogranule, microgranule, oil dispersible powder, oil miscible flowable concentrate, oil miscible liquid, paste, plate bait, scrap bait, smoke candle, smoke cartridge, smoke generator, smoke pellet, smoke rodlet, smoke tablet, smoke tin, soluble concentrate, soluble powder, suspension concentrate, oil dispersible or suspension in oil, tracking powder, ultra low volume (ulv) liquid, ultra low volume (ulv) suspension, vapour releasing product, water dispersible granules or tablets, water dispersible powder for slurry treatment, water soluble granules or tablets, or water soluble powder for seed treatment and wettable powder or any other forms of slow release/controlled release formulations.

In another aspect, the disclosure provides for a compound, composition, device, support material, kit, as well a method of attracting, detecting, eradicating, controlling, regulating or influencing the behavior of and/or killing a pest by utilizing a pesticidal compound described herein (i.e., a composition including a pesticide (e.g., permethrin) and an organic nitrogenous compound (e.g., histamine)).

The disclosure also provides for a detection device for monitoring or detecting bed bug infestation, comprising a first plate and a second plate, wherein the first plate and the second plate are separated by an internal spacing sized to permit entry into the detection device by a bed bug; and a composition including a pesticide (e.g., permethrin) and an organic nitrogenous compound (e.g., histamine) for attracting, detecting, eradicating, controlling, regulating or influencing the behavior of and/or killing a pest.

In an aspect, the disclosure provides for a support material combined with a compound or composition described herein. In another aspect, the support material can be coated or impregnated with a pest attractant, arresting, and/or aggregation compound or composition described herein. A pesticide can also be added to the support material coated or impregnated with an attractant, arresting, and/or aggregation compound or composition described herein. In another aspect, the composition, device, or support material does not include a pesticide. Examples of support materials capable of being used with compounds described herein include an absorbent material, wood, cardboard, corrugated cardboard, cotton, wallpaper, paper, plastic, a plastic tube, and metal. Support materials with a low heat transfer rate may also be suitable.

In another aspect, the support material combined with an attractant, arresting, and/or aggregation compound or composition described herein can be used to monitor or attract pests, such as bed bugs. In one aspect, the support material is combined with an attractant, arresting, and/or aggregation compound described herein and a pesticide. Such a support material can be used in a method of eradicating or killing pests. The support material can also be used in conjunction with a device, such as a pest trap or pest detection device or monitor. Without being limited, the detection devices described herein can be used with the support material. In another aspect, the pest trap, detection device, or monitor is specific for bed bugs.

In another aspect, the disclosure also provides for a method of luring or arresting a pest into an area treated with a pest attractant, arresting, and/or aggregation compound described herein. In an aspect, a pest, such as a bed bug, is arrested in a given area for about 1 minute, about 10 minutes, about 30 minutes, about 1 hour, about 8 hours, about 24 hours, about 2 days, about 7 days, about 2 weeks, or about 1 month. In one aspect, a support material is present in the treated area. In another aspect, a pest, such as a bed bug, is arrested in a given area for from about 1 hour to about 8 hours, from about 12 hour to about 2 days, or from about 1 day to about 7 days.

In one aspect, a support material is present in the treated area. In another aspect, the support material is capable of being coated, impregnated, or sprayed with a compound described herein. Without being limited, the support material can be an absorbent material, wood, cardboard, corrugated cardboard, cotton, wallpaper, paper, plastic, a plastic tube, or metal. In an aspect, the treated area can be, for example, a bed, a pillow, a pillow case, a mattress, a box spring, a bed frame, a headboard, a sheet, a carpet, furniture, a picture frame, a book case, an upholstered chair, a sofa and wood furniture, along and beneath a baseboard, a floor area, under a bed and a couch or any place a bed bug is prone to rest or hide.

In accordance with a further aspect, there is provided a method for monitoring the presence of pests, such as bed bugs, in multiple discreet areas such as in hotel rooms, bedrooms, animal holding areas such as chicken houses, barn stalls, etc. In accordance with this method, a device which allows for the entry of a pest such as bed bug may be placed in each location sought to be monitored. There can be one device or hundreds or more devices depending on how many discreet areas need to be monitored separately. For example, in a hotel, a separate device could be mounted to each bed in each room in the hotel. The device can be any desired device, for example, the device as disclosed herein. In an aspect, the device or devices can be checked on a periodic basis, for example, weekly, biweekly, every 24 hours, or as desired, and if the device has evidence of pest contact such as by viewing the pest in the device, then the area where that particular device was mounted is then subjected to a treatment regime to eliminate or reduce the activity of the pest in that area.

In another aspect, the disclosure provides for a method of treating, controlling, monitoring, or detecting bed bug infestation comprising adding a pest attractant, arresting, and/or aggregation compound described herein to a support material, detection device, or trap and placing the support material, device, or trap in an area prone to bed bug infestation. In another aspect, the support material, detection device, or trap is placed in an area after identification of bed bug infestation. In yet another aspect, the support material, detection device, or trap is placed in an area prior to identification of bed bug infestation. In another aspect, the disclosure provides a method of killing or eradicating bed bugs comprising adding an attractant, arresting, and/or aggregation compound or composition described herein to a support material, detection device, or trap and placing the support material, device, or trap in an area prone to bed bug infestation.

In an aspect, the area prone to bed bug infestation includes, for example, a bed, a pillow, a pillow case, a mattress, a box spring, a bed frame, a headboard, a sheet, a carpet, furniture, a picture frame, a book case, an upholstered chair, a sofa and wood furniture, along and beneath a baseboard, a floor area, under a bed and a couch or any place a bed bug is prone to rest or hide. In another aspect, from about 1 to about 6, from about 2 to about 4, or from about 1, 2, 3, 4, 5, 6, 7, 8, 9, or 10 or more detection devices, traps, or support materials are placed in an area prone to bed bug infestation. In yet another aspect, the device, trap, or support material is evaluated by an individual or PMP for bed bug infestation from about 1 to about 5 times, about 1 to about 3 times, or from about 2 to about 4 times a day, from about 1 to about 10 times, from about 3 to about 8 times, or from about 1 to about 5 times a week, or from about 1 to about 30 times, from about 5 to about 20 times, from about 1 to about 5 times a month.

In an aspect according to the disclosure, the pest is an insect and the insect is a bed bug. In another aspect, the bed bug is from the species Cimex lectularius, Cimex hemipterus, Leptocimex boueti, Cimex pilosellus, Cimex pipistrella, or Haematosiphon inodora. In yet another aspect, the bed bug is from Cimex sp. or other genera in the Cimicidae family, for example the genus Haematosiphon, or the genus Oeciacus. In a further aspect, the bed bug is a first, second, third, fourth, or fifth instar. In another aspect, the bed bug is a fourth or fifth instar bed bug. In a further aspect, the bed bug is a large nymph bed bug. In another aspect, the bed bug is an adult.

In an aspect, the methods, compositions, and devices may be practiced with additional pests, such as blood-feeding Reduviidae, for example a kissing bug, or other Heteroptera that aggregate during all or part of their life cycle. In another aspect, the methods, compositions, and devices may be practiced with additional pests, such as mosquitoes, lice, ticks, fleas, deer ticks, poultry lice or other arthropods such as tick and mite species. In yet another aspect, the methods, compositions, and devices may be practiced with additional arthropods or blood feeding animals or pests. In an aspect, the behavior of the above groups may be altered by common chemical or biological compounds. In yet another aspect, the above groups are attracted, arrested, or aggregated by compounds, such as the ones described herein.

In another aspect, the disclosure provides for a detection device including a compound or composition as described herein.

A method for detecting the presence of bed bugs using devices and compounds described herein is also provided. The method allows for the detection of bed bugs even when there are no bed bugs visible at the time of evaluation of the detection. Generally, any test system can be used, for example, a detection system which allows for a visual count and observation.

Bed bugs are attracted to materials with a rough surface texture and surface porosity. Examples of materials that may be used to form the detection device itself and/or be incorporated into the detection device include wood, cardboard, corrugated cardboard, cotton, or wallpaper. Materials with a low heat transfer rate may also be suitable in some cases.

In an aspect, if pests such as bed bugs are detected in one of the areas being monitored, bed linens and clothing can be first removed from the area. Beds can then be disassembled and bed bug-infested mattresses, box springs, couches or other belongings can be discarded. The area can then be treated with attractant, arresting, and/or aggregation compounds and compositions according to the disclosure in conjunction with any pesticide known to be active against the pest that has infested the area.

In an aspect, after treatment, additional follow-up inspections can be made, for example, on a biweekly basis. Since bed bugs are often hard to eradicate, to achieve the desired outcome, thorough inspections and repeated applications should be made and a sufficient quantity of pesticide should be used. The amount of time spent in each infested area on the initial treatment can range from 1 to 2 hours, with each follow-up service or treatment can last at least an additional hour or more. Once an area has been treated, a new device can be installed in that area for future monitoring of the presence of pests.

Also provided is a kit comprising a compound or composition as described herein. In one aspect, the kit comprises a composition including a pest attractant, arresting, and/or aggregation compound and a pesticide compound.

The kit may also include instructions for describing procedures associated with the disclosed methods. In yet another aspect, the kit comprises instructions for using a compound or composition as described herein for attracting, arresting, aggregating, detecting, controlling, eradicating, or killing a pest. In an aspect, the kit is configured to treat, detect, or control bed bug infestation.

In another aspect, the kit comprises a pest detection device, support material, bait, or trap as described herein together with a compound or composition as described herein. The kit may also include a pesticide or other composition component as described herein. In yet another aspect, the kit does not include a pesticide.

In another aspect, the kit can contain a single-use disposable detection device, bait, support material, or trap. The kit may also contain a reusable multi-use detection device, bait, support material, or trap.

In another aspect, the kit may include a supplement to the detection device, bait, support material, or trap. For example, the supplemental kit may contain an additional bait composition or other supplement to the to the detection device, bait, support material, or trap. In one aspect, the supplemental kit is packaged separate from the detection device, bait, support material, or trap. In another aspect, the supplemental kit is packaged together with the detection device, bait, support material, or trap.

In some aspects, the disclosure provides methods for pest control comprising contacting a pest with an amount of any of the compositions described in this specification. As used in this specification, pests may include, but are not limited to, bed bugs as described herein.

Other pests include, for example, mosquitoes. Mosquito is understood to refer to any species of the approximately 3,500 species of the insect that is commonly associated with and given the common name, “mosquito.” Mosquitoes span 41 insect genera, including the non-limiting examples of Aedes, Culex, Anopheles (carrier of malaria), Coquillettidia, and Ochlerotatus. A mosquito can refer to an adult mosquito or a larval mosquito or both. Thus, some embodiments describe methods or compositions wherein the insecticidal activity is referred to as mosquito “adulticide” or alternatively a mosquito “larvacide.” Insects may further include agronomic pests including, but not limited to, insects of the orders Lepidoptera (moths), Coleoptera (beetles), and Hemiptera (sucking insects, true bugs). Contacting a pest with a composition includes, but is not limited to, exposing a pest or a population of pests either by direct contact using any method described in this specification or known in the art, such as by topical application, or by indirect contact such as by inhalation of a vapor, spray, mist, aerosol or fog or by ingestion of the composition by the pest.

Illustrative agronomic pests include larvae of the order Lepidoptera, such as armyworms, (e.g., beet armyworm (Spodoptera exigua)), cutworms, loopers, (e.g., cabbage looper (Trichoplusia ni)) and heliothines in the family Noctuidae (e.g., fall armyworm (Spodoptera fugiperda J. E. Smith), beet armyworm (Spodoptera exigua Hubner), black cutworm (Agrotis ipsilon Hufnagel), and tobacco budworm (Heliothis virescens Fabricius)); borers, casebearers, webworms, coneworms, cabbageworms and skeletonizers from the family Pyralidae (e.g., European corn borer (Ostrinia nubilalis Hubner), navel orangeworm (Amyelois transitella Walker), corn root webworm (Crambus caliginosellus Clemens), and sod webworms (Pyralidae: Crambinae) such as sod webworm (Herpetogramma licarsisalis Walker)); leafrollers, budworms, seed worms, and fruit worms in the family Tortricidae (e.g., codling moth (Cydia pomonella Linnaeus), grape berry moth (Endopiza viteana Clemens), and oriental fruit moth (Grapholita molesta Busck)); and many other economically important Lepidoptera (e.g., diamondback moth (Plutella xylostella Linnaeus), pink bollworm (Pectinophora gossypiella Saunders), and gypsy moth (Lymantria dispar Linnaeus)); foliar feeding larvae and adults of the order Coleoptera including weevils from the families Anthribidae, Bruchidae, and Curculionidae (e.g., boll weevil (Anthonomus grandis Boheman), rice water weevil (Lissorhoptrus oryzophilus Kuschel), granary weevil (Sitophilus granarius Linnaeus), rice weevil (Sitophilus oryzae Linnaeus), annual bluegrass weevil (Listronotus maculicollis Dietz), bluegrass billbug (Sphenophorus parvulus Gyllenhal), hunting billbug (Sphenophorus venatus vestitus), and Denver billbug (Sphenophorus cicatristriatus Fahraeus)); flea beetles, cucumber beetles, rootworms, leaf beetles, potato beetles, and leafminers in the family Chrysomelidae (e.g., Colorado potato beetle (Leptinotarsa decemlineata Say)); western corn rootworm (Diabrotica virgifera virgifera LeConte); western flower thrip (Frankliniella occidentalis)); chafers and other beetles from the family Scaribaeidae (e.g., Japanese beetle (Popillia japonica Newman), oriental beetle (Anomala orientalis Waterhouse), northern masked chafer (Cyclocephala borealis Arrow), southern masked chafer (Cyclocephala immaculate Olivier), black turfgrass ataenius (Ataenius spretulus Haldeman), green June beetle (Cotinis nitida Linnaeus), Asiatic garden beetle (Maladera castanea Arrow), May/June beetles (Phyllophaga spp.) and European chafer (Rhizotrogus majalis Razoumowsky)); carpet beetles from the family Dermestidae; wireworms from the family Elateridae; bark beetles from the family Scolytidae; flour beetles from the family Tenebrionidae; leafhoppers (e.g., Empoasca spp.) from the family Cicadellidae; planthoppers from the families Fulgoroidae and Delphacidae (e.g., corn plant hopper (Peregrinus maidis)); treehoppers from the family Membracidae; psyllids from the family Psyllidae; whiteflies from the family Aleyrodidae; silverleaf whitefly (Bemisia argentifolii) of the order Hemiptera; aphids from the family Aphididae, such as Aphis gossypii (cotton melon aphid), Acyrthisiphon pisum Harris (pea aphid), Aphis craccivora Koch (cowpea aphid), Aphis fabae Scopoli (black bean aphid), Aphis gossypii Glover (cotton aphid, melon aphid), Aphis pomi De Geer (apple aphid), Aphis spiraecola Patch (spirea aphid), Aulacorthum solani Kaltenbach (foxglove aphid), Chaetosiphon fragaefolii Cockerell (strawberry aphid), Diuraphis noxia Kurdjumov/Mordvilko (Russian wheat aphid), Dysaphis plantaginea Paaserini (rosy apple aphid), Eriosoma lanigerum Hausmann (woolly apple aphid), Hyalopterus pruni Geoffroy (mealy plum aphid), Lipaphis erysimi Kaltenbach (turnip aphid), Metopolophium dirrhodum Walker (cereal aphid), Macrosipum euphorbiae Thomas (potato aphid), Myzus persicae Sulzer (peach-potato aphid, green peach aphid), Nasonovia ribisnigri Mosley (lettuce aphid), Pemphigus spp. (root aphids and gall aphids), Rhopalosiphum maidis Fitch (corn leaf aphid), Rhopalosiphum padi Linnaeus (bird cherry-oat aphid), Schizaphis graminum Rondani (greenbug), Sitobion avenae Fabricius (English grain aphid), Therioaphis maculata Buckton (spotted alfalfa aphid), Toxoptera aurantii Boyer de Fonscolombe (black citrus aphid), and Toxoptera citricida Kirkaldy (brown citrus aphid); phylloxera from the family Phylloxeridae; mealybugs from the family Pseudococcidae; scales from the families Coccidae, Diaspididae, and Margarodidae; lace bugs from the family Tingidae; stink bugs from the family Pentatomidae; flat mites in the family Tenuipalpidae (e.g., citrus flat mite (Brevipalpus lewisi McGregor)); rust and bud mites in the family Eriophyidae and other foliar feeding mites; chinch bugs (e.g., hairy chinch bug (Blissus leucopterus hirtus Montandon) and southern chinch bug (Blissus insularis Barber) and other seed bugs from the family Lygaeidae); spittlebugs from the family Cercopidae; squash bugs from the family Coreidae; red bugs and cotton stainers from the family Pyrrhocoridae; and adults and immatures of the order Orthoptera including grasshoppers, locusts, and crickets (e.g., migratory grasshoppers (e.g., Melanoplus sanguimpes Fabricius, M. differentialis Thomas)), American grasshoppers (e.g., Schistocerca americana Drury), desert locust (Schistocerca gregaria Forskal), migratory locust (Locusta migratoria Linnaeus), bush locust (Zonocerus spp.); adults and immatures of the order Diptera including leafminers, midges, fruit flies (Tephritidae), frit flies (e.g., Oscinella frit Linnaeus), soil maggots, adults and nymphs of the orders Hemiptera and Homoptera such as plant bugs from the family Miridae; adults and immatures of the order Thysanoptera including onion thrips (Thrips tabaci Lindeman), flower thrips (Frankhniella spp.), and other foliar feeding thrips; and cicadas from the family Cicadidae. Agronomic pests also include Classes Nematoda, Cestoda, Trematoda, and Acanthocephala including economically important members of the orders Strongylida, Ascaridida, Oxyurida, Rhabditida, Spirurida, and Enoplida such as economically important agricultural pests (e.g., root knot nematodes in the genus Meloidogyne, lesion nematodes in the genus Pratylenchus, and stubby root nematodes in the genus Trichodorus).

Other illustrative agronomic and non-agronomic pests include nymphs and adults of the order Blattodea including cockroaches from the families Blattellidae and Blattidae (e.g., oriental cockroach (Blatta orientalis Linnaeus), Asian cockroach (Blatella asahinai Mizukubo), German cockroach (Blattella germanica Linnaeus), brownbanded cockroach (Supella longipalpa Fabricius), American cockroach (Periplaneta americana Linnaeus), brown cockroach (Periplaneta brunnea Burmeister), Madeira cockroach (Leucophaea maderae Fiabricius), smoky brown cockroach (Periplaneta fuliginosa Service), Australian Cockroach (Periplaneta australasiae Fabr.), lobster cockroach (Nauphoeta cinerea Olivier) and smooth cockroach (Symploce pallens Stephens)); adults and larvae of the order Dermaptera including earwigs from the family Forficulidae (e.g., European earwig (Forficula auricularia Linnaeus), and black earwig (Chelisoches morio Fabricius)). Also included are adults and larvae of the order Acari (mites) such as spider mites and red mites in the family Tetranychidae (e.g., European red mite (Panonychus ulmi Koch), two spotted spider mite (Tetranychus urticae Koch), and McDaniel mite (Tetranychus mcdanieli McGregor)); mites important in human and animal health (e.g., dust mites in the family Epidermoptidae, follicle mites in the family Demodicidae, grain mites in the family Glycyphagidae, and bird mites in the family Dermanyssidae and the family Macronyssidae); ticks in the order Ixodidae (e.g., deer tick (Ixodes scapularis Say), Australian paralysis tick (Ixodes holocyclus Neumann), American dog tick (Dermacentor variabilis Say), and lone star tick (Amblyomma americanum Linnaeus)); scab and itch mites in the families Psoroptidae, Pyemotidae, and Sarcoptidae; crickets such as house cricket (Acheta domesticus Linnaeus), mole crickets (e.g., tawny mole cricket (Scapteriscus vicinus Scudder), and southern mole cricket (Scapteriscus borellii Giglio-Tos)); flies including house flies (e.g., Musca domestica Linnaeus), lesser house flies (e.g., Fannia canicularis Linnaeus, F. femoralis Stein), stable flies (e.g., Stomoxys calcitrans Linnaeus), face flies, horn flies, blow flies (e.g., Chrysomya spp., Phormia spp.), and other muscoid fly pests, horse flies (e.g., Tabanus spp.), bot flies (e.g., Gastrophilus spp., Oestrus spp.), cattle grubs (e.g., Hypoderma spp.), deer flies (e.g., Chrysops spp.), keds (e.g., Melophagus ovinus Linnaeus) and other Brachycera; mosquitoes (e.g., Aedes spp., Anopheles spp., Culex spp.), black flies (e.g., Prosimulium spp., Simulium spp.), biting midges, sand flies, sciarids, and other Nematocera; insect pests of the order Hymenoptera including ants (e.g., red carpenter ant (Camponotus ferrugineus Fabricius), black carpenter ant (Camponotus pennsylvanicus De Geer), Pharaoh ant (Monomorium pharaonis Linnaeus), little fire ant (Wasmannia auropunctata Roger), fire ant (Solenopsis geminata Fabricius), red imported fire ant (Solenopsis invicta Buren), Argentine ant (Iridomyrmex humilis Mayr), crazy ant (Paratrechina longicomis Latreille), pavement ant (Tetramorium caespitum Linnaeus), cornfield ant (Lasius alienus Forster), odorous house ant (Tapinoma sessile Say)); insect pests of the Family Formicidae including the Florida carpenter ant (Camponotus floridanus Buckley), white-footed ant (Technomyrmex albipes fr. Smith), big headed ants (Pheidole spp.), and ghost ant (Tapinoma melanocephalum Fabricius); bees (including carpenter bees), hornets, yellow jackets, wasps, and sawflies (Neodiprion spp.; Cephus spp.); insect pests of the order Isoptera including termites in the Termitidae (ex. Macrotermes sp.), Kalotermitidae (ex. Cryptotermes sp.), and Rhinotermitidae (ex. Reticulitermes spp., Coptotermes spp.), families the eastern subterranean termite (Reticulitermes flavipes Kollar), western subterranean termite (Reticulitermes hesperus Banks), Formosan subterranean termite (Coptotermes formosanus Shiraki), West Indian drywood termite (Incisitermes immigrans Snyder), powder post termite (Cryptotermes brevis Walker), drywood termite (Incisitermes snyderi Light), southeastern subterranean termite (Reticulitermes virginicus Banks), western drywood termite (Incisitermes minor Hagen), arboreal termites such as Nasutitermes sp. and other termites of economic importance; insect pests of the order Thysanura such as silverfish (Lepisma saccharina Linnaeus) and firebrat (Thermobia domestica Packard); insect pests of the order Mallophaga and including the head louse (Pediculus humanus capitis De Geer), body louse (Pediculus humanus humanus Linnaeus), chicken body louse (Menacanthus stramineus Nitszch), dog biting louse (Trichodectes canis De Geer), fluff louse (Goniocotes gallinae De Geer), sheep body louse (Bovicola ovis Schrank), short-nosed cattle louse (Haematopinus eurysternus Nitzsch); long-nosed cattle louse (Linognathus vituli Linnaeus) and other sucking and chewing parasitic lice that attack man and animals; insect pests of the order Siphonoptera including the oriental rat flea (Xenopsylla cheopis Rothschild), cat flea (Ctenocephalides felis Bouche), dog flea (Ctenocephalides canis Curtis), hen flea (Ceratophyllus gallinae Schrank), sticktight flea (Echidnophaga gallinacea Westwood), human flea (Pulex irritans Linnaeus) and other fleas afflicting mammals and birds. Arthropod pests also include spiders in the order Araneae such as the brown recluse spider (Loxosceles reclusa Gertsch & Mulaik) and the black widow spider (Latrodectus mactans Fabricius), and centipedes in the order Scutigeromorpha such as the house centipede (Scutigera coleoptrata Linnaeus).

In some embodiments, the method comprises contacting a pest with an amount of any of the compositions of this disclosure effective to control at least about 20%, at least about 30%, at least about 40%, at least about 50%, less than about 100%, less than about 90%, less than about 80%, less than about 70%, or less than about 60% of the contacted adult pest population. In some embodiments, the method comprises contacting a pest with an amount of any of the compositions described herein effective to provide about 95% pest mortality.

In some embodiments, methods for pest control or controlling pests comprise contacting a pest with an amount of any of the compositions described in this specification. Control or controlling includes killing, knocking down, or a combination thereof, of at least a portion of a population of pests. A population includes at least two pests. Pest knockdown does not necessarily correlate to pest death, as pests can recover after the initial knockdown. In some embodiments, the composition is applied in an amount effective to knockdown at least about 20%, at least about 30%, at least about 40%, at least about 50%, at least about 60%, at least about 70%, at least about 80%, at least about 90%, at least about 95%, or at least about 98% of the contacted pest population. In some embodiments, the composition is applied in an amount effective to kill at least about 20%, at least about 30%, at least about 40%, at least about 50%, at least about 60%, at least about 70%, at least about 80%, at least about 90%, at least about 95%, or at least about 98% of the contacted pest population.

In some embodiments, the methods described here can comprise any known route, apparatus, and/or mechanism for the delivery or application of the compositions and formulations. In some embodiments, compositions may be applied as an aerosol, mist, fog, vapor, or ULV spray. In some embodiments, compositions may be applied as a surface contact treatment. A surface contact treatment includes surfaces that have been contacted with the composition, such as by painting, rolling, coating, dip coating or spraying the surface, or the compositions may be incorporated into fibers or other materials, such as, for example, a bednet to produce a material comprising a surface contact treatment. In some embodiments, the method comprises a sprayer. Traditional pesticide sprayers in the pest control markets are typically operated manually or electrically or are gas-controlled and use maximum pressures ranging from 15 to 500 psi generating flow rates from 5 gpm to 40 gpm.

In other embodiments, the methods disclosed here comprise the use of the compositions and/or formulations in combination with any low volume environmental pest control device(s) such as, for example, ultra low volume (ULV) machines. Such combinations are useful in methods for mosquito control as well as other flying pests (e.g., flies, gnats, and flying ants) wherein contacting the pest with a low volume of the composition is possible and/or desirable. ULV machines suitably use low volume of material, for example at rates of about one gallon per hour (or ounces per minute), and typically utilize artificial wind velocities such as from, for example, an air source (e.g., pump or compressor) to break down and distribute the composition/formulation into a cold fog (suitably having average droplet particle sizes of about 1-30 μm). Any standard ground ULV equipment used for pest control such as, for example, a system including a (CETI) Grizzly aerosol generator can be used in the methods described here. A general ULV system includes a tank for the composition (e.g., insecticide), a transport system (e.g., a pump or pressurized tank), a flow control device, and a nozzle that atomizes the composition. Typically, ULV machines do not compress droplets. Rather, they often use a venture siphoning system, and can induce an artificial energizing of the droplets by adding an electrical current to the liquid (e.g., through the use an electrode located at the application tip).

It is to be understood that any numerical range recited in this specification includes all values from the lower value to the upper value. For example, if a concentration range is stated as 1% to 50%, it is intended that values such as 2% to 40%, 10% to 30%, or 1% to 3%, etc., are expressly enumerated in this specification. It is also to be understood that any numerical range recited in this specification includes all values from at least the lower value without an upper limit, and all values up to the upper value without a lower limit. These are only examples of what is specifically intended, and all possible combinations of numerical values between and including the lowest value and the highest value enumerated are to be considered to be expressly stated in this application.

While we have shown and described several embodiments in accordance with our disclosure, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. A method for controlling or killing pests, the method comprising providing at a location a composition comprising a pest toxicant and an organic nitrogenous compound, wherein the organic nitrogenous compound is capable of attracting, arresting, aggregating and/or altering the behavior of the pests at the location.

2. The method of claim 1 wherein the pest toxicant comprises (i) at least one of a carbamate, pyrethroids, a phenylpyrazole, a chloronicotinyle, a imidacloprid, an acetamiprid, a thiacloprid, a thiamethoxam, a nitenpyram, a clothianidin, a oxadiazine, an anthranilic diamide, a butenolide, a sulfoximine, an indoxacarb, a rynaxypyr, or mixtures thereof; or (ii) at least one of a pyrethrum, a pyrethrin, a pyrethroid, a spinosad, a neonicotinoid, a sulfoxoflor, a carbamate, an organophosphate, an organochlorine, or mixtures thereof.

3. The method of claim 1 wherein the pest toxicant comprises at least one of phosphoric esters selected from acephate, chlorpyrifos, dichlorovos, malathion or propetamphos; carbamates selected from bendiocarb, carbaryl, or propoxur; pyrethroids selected from allethrin, bifenthrin, bioallethrin, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, esfenvalerate, etofenprox, fenpropathrin, fenvalerate, flumethrin, tau-fluvalinate, halfenprox, imiprothrin, permethrin, phenothrin, prallethrin, pyrethrins (pyrethrum), resmethrin, silafluofen, tefluthrin, tetramethrin or transfluthrin; nitroimines and nitromethylenes selected from 1-[(6-chloro-3-pyridinyl)-methyl]-4,5-dihydro-N-nitro-1H-imidazol-2-amine (imidacloprid), N—R6-chloro-3-pyridyl)methyldN²-cyano-N¹-methylacetamide (NI-25); phenylpyrazoles selected from fipronil or ethiprole; avermectins selected from abamectin or emamectin benzoate; spinosyns selected from spinosad or spinetoram; oxadiazines selected from indoxacarb or metaflumizone; anthranilic diamides selected from flubendiamid, chlorantraniliprole or cyantraniliprole; sulfoximines selected from sulfoxaflor; insect growth regulators selected from methoprene, chlorfluazuron, flufenoxuron, pyriproxyfen, triflumuron or flufenoxuron; and insecticidally active compounds selected from azadirachtin, chlorfenapyr, hydramethylnon, petroleum oils or botanical oils; and mixtures thereof.

4. The method of claim 1 wherein the pest toxicant comprises at least one of the compounds of the structure (I) 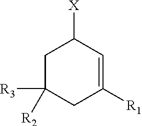
wherein X is selected from —OH, ═O, —O(O)CR, where R is selected from H and a branched or straight chain, saturated or unsaturated hydrocarbyl group with zero to three double bonds and from 1 to 11 carbon atoms;
R₁ is selected from H, CH₃;
R₂ is selected from H, CH₃;
R₃ is selected from H and a branched or straight chain, saturated or unsaturated hydrocarbyl group with zero to three double bonds and from 1 to 11 carbon atoms, and
wherein the compounds of structure (I) contain from 6 to 20 total carbon atoms in the compounds.

5. The method of claim 4 wherein the at least one compound of structure (I) is selected from the group consisting of:

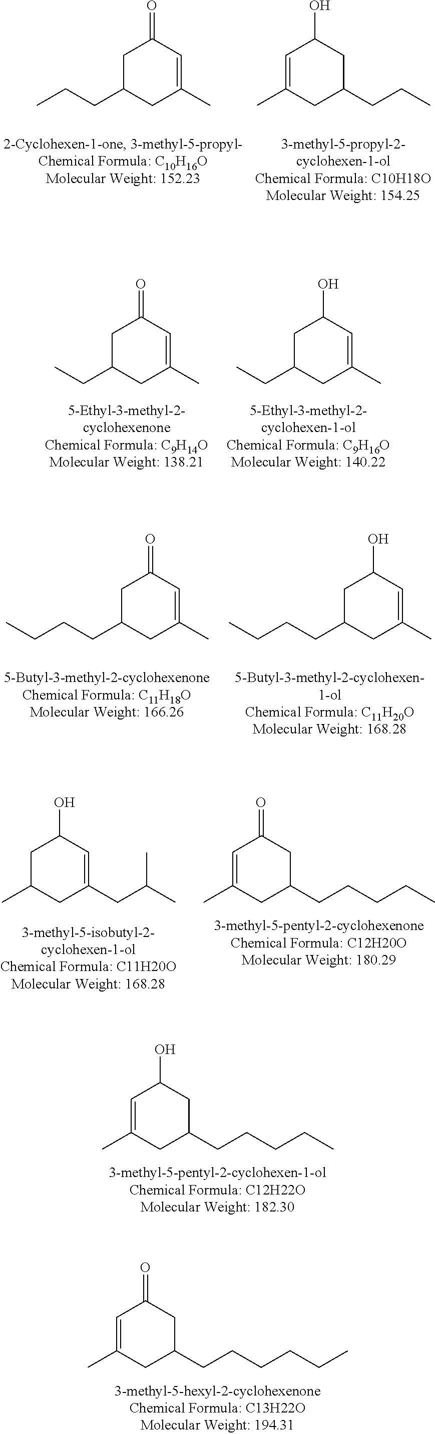

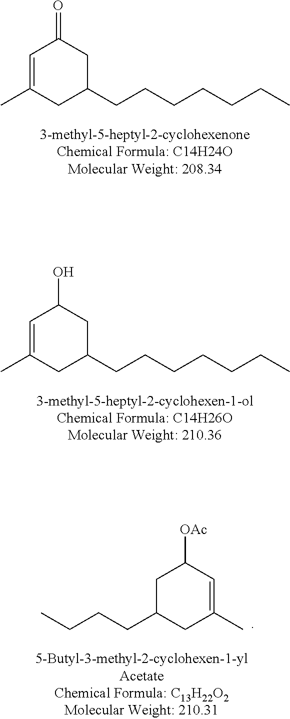

6. The method of claim 4 wherein at least one compound of structure (I) is selected from the group consisting of 3-methyl-5-propyl-2-cyclohexen-1-one, 3-methyl-5-propyl-2-cyclohexen-1-ol and 3-methyl-5-ethyl-2-cyclohexen-1-one for vapor toxicity.

7. The method of claim 4 wherein at least one compound of structure (I) is selected from the group 3-methyl-5-butyl-2-cyclohexen-1-one, 3-methyl-5-pentyl-2-cyclohexen-1-one, 3-methyl-5-hexyl-2-cyclohexen-1-one and 3-methyl-5-heptyl-2-cyclohexen-1-one for contact toxicity.

8. The method of claim 1 wherein the organic nitrogenous compound comprises histamine.

9. The method of claim 1 wherein the composition comprises (i) a pest toxicant, histamine, and an attractant or aggregant compound; (ii) permethrin, histamine, and an attractant or aggregant compound; or (iii) a pyrethroid, histamine, and an attractant or aggregant compound.

10. The method of claim 9 wherein the attractant or aggregant compound comprises carbon dioxide, ammonia, heat, methanol, methane, furan, pyridine, human perspiration, lactic acid, butyric acid, octenol, trans-2-octenal, trans-2-hexenal, 2-butanone, lactic acid, indole, 6-methyl-5-hepten-2-one, geranyl acetone, 1-dodecanol, 3-methyl-1-butanol, carboxylic acids, urea, sebum, or mixtures thereof.

11. The method of claim 1 wherein the pest toxicant is present in an amount from at least about 0.005%, at least about 0.01%, at least about 0.05%, at least about 0.1%, at least about 0.5%, at least about 1%, at least about 2%, at least about 3%, at least about 4%, at least about 6%, at least about 8%, at least about 10%, at least about 12%, at least about 15%, at least about 20%, at least about 25%, at least about 30%, at least about 35%, at least about 40%, at least about 50%, at least about 55%, at least about 60%, at least about 65%, at least about 70%, at least about 75%, at least about 80%, at least about 85%, at least about 90%, at least about 95%, and less than about 95%, less than about 90%, less than about 80%, less than about 75%, less than about 70%, less than about 65%, less than about 60%, less than about 55%, less than about 50%, less than about 45%, less than about 35%, less than about 30%, less than about 25%, less than about 20%, less than about 15%, less than about 10%, less than about 5%, less than about 2.5%, less than about 2%, less than about 1%, less than about 0.5%, or less than about 0.1% by weight of the composition.

12. The method of claim 1 wherein the organic nitrogenous compound is present in an amount from at least about 0.005%, at least about 0.01%, at least about 0.05%, at least about 0.1%, at least about 0.5%, at least about 1%, at least about 2%, at least about 3%, at least about 4%, at least about 6%, at least about 8%, at least about 10%, at least about 12%, at least about 15%, at least about 20%, at least about 25%, at least about 30%, at least about 35%, at least about 40%, at least about 50%, at least about 55%, at least about 60%, at least about 65%, at least about 70%, at least about 75%, at least about 80%, at least about 85%, at least about 90%, at least about 95%, and less than about 95%, less than about 90%, less than about 80%, less than about 75%, less than about 70%, less than about 65%, less than about 60%, less than about 55%, less than about 50%, less than about 45%, less than about 35%, less than about 30%, less than about 25%, less than about 20%, less than about 15%, less than about 10%, less than about 5%, less than about 2.5%, less than about 2%, less than about 1%, less than about 0.5%, or less than about 0.1% by weight of the composition.

13. The method of claim 1 wherein the pests comprise insects.

14. The method of claim 1 wherein the pests comprise one or more of bed bugs, mosquitoes, biting flies, fleas, ticks, mites, and blood feeding insects.

15. The method of claim 1 wherein the composition is applied to a surface of clothing or fabric or impregnated into clothing or fabric.

16. The method of claim 1 wherein the composition is applied in the form of a wipe, powder, spray, or liquid.

17. The method of claim 1 wherein the composition is applied to furniture, building supplies, electronic devices, cargo or storage areas.

18. A method of attracting, arresting, aggregating and/or altering the behavior of pests at a location, the method comprising providing at the location a composition comprising an organic nitrogenous compound.

19. A composition comprising a pest toxicant and an organic nitrogenous compound capable of attracting, arresting, aggregating and/or altering the behavior of one or more pests.

20. A composition comprising an organic nitrogenous compound capable of attracting, arresting, aggregating and/or altering the behavior of one or more pests.
